(19) United States
(12) Patent Application Publication
(10) Pub. No.: US 2019/0165944 A1
(43) Pub. Date: May 30, 2019

(54) ALTERNATIVE DATA PROTECTION RULES FOR DEVICE AUTHENTICATION

(71) Applicant: International Business Machines Corporation, Armonk, NY (US)

(72) Inventors: Lin Sun, Cary, NC (US); Liam S. Harpur, Skerries (IE); Aaron James Quirk, Raleigh, NC (US)

(21) Appl. No.: 15/822,428

(22) Filed: Nov. 27, 2017

(51) Int. Cl. H04L 9/32; H04W 12/06; G06F 21/31

(52) U.S. Cl. CPC H04L 9/3226; H04L 9/3297; G06F 21/31; H04W 12/06; H04L 9/3271

(57) ABSTRACT

Providing authentication of a device includes determining whether a received passcode entry matches an authorized passcode stored in device memory and when it does not match, executing a notification to indicate that the received passcode is an incorrect passcode and requesting entry of another passcode. In response to determining that a consecutive threshold number of received passcodes do not match an authorized passcode entry stored in the device memory, the device determines whether the threshold number of received passcodes meets a predetermined quality threshold. In response to determining that the threshold number of received passcodes meets the predetermined quality threshold, an alert is transmitted to an authentication service. The device then receives a partial authentication response from the authentication service, and based on the partial authentication response, the device uses an alternate data protection rule for passcode authentication.

### BACKGROUND OF THE INVENTION

This invention relates generally to mobile devices and more specifically to passcode authentication of mobile devices.

Passcode authentication of users requesting access to a device or service has been and continues to be widely used in information technology. Passcodes used to regulate access to mobile devices can often be short and rely on a limited set of options (such as numeric only); accordingly, providers incorporate tamper resistance and data protection features, such as lockouts and data erasure when passcodes are erroneously entered after a number of attempts. The modified authentication system presented herein can be utilized to provide necessary security while also providing flexibility to protect legitimate users from the negative consequences of data protection mechanisms.

### SUMMARY

Embodiments of the present invention disclose a method, system and computer product for providing authentication of a device. A passcode entry is received at a device, which determines whether it matches an authorized passcode stored in device memory, and when the passcode entry does not match, executes a notification to indicate that the received passcode is an incorrect passcode and requests entry of another passcode. The device then determines that a consecutive threshold number of received passcodes do not match an authorized passcode entry stored in the first device memory and determines whether the threshold number of received passcodes meets a predetermined quality threshold. An alert is transmitted to an authentication service when the threshold number of received passcodes meets the predetermined quality threshold. The device then receives a partial authentication response from the authentication service, and based on the partial authentication response, the device uses an alternate data protection rule for passcode authentication.

### BRIEF DESCRIPTION OF THE DRAWINGS

FIG. 1 is a logic diagram of an example of a method of performing modified authentication using passcodes in accordance with the present invention;

FIG. 2 is a logic diagram of another example of a method of performing modified authentication using passcodes in accordance with the present invention;

FIG. 3 is a logic diagram of another example of a method of performing modified authentication using passcodes in accordance with the present invention;

FIG. 4 depicts a schematic of a passcode quality threshold decision engine in accordance with the present invention the present invention;

FIG. 5 depicts a digital telecommunications environment according to various embodiments of the present invention;

FIG. 6 depicts a passcode entry field for a mobile device according to various embodiments of the present invention;

FIG. 7 depicts a schematic of the functional elements of an example mobile device according to various embodiments of the present invention.

### DETAILED DESCRIPTION

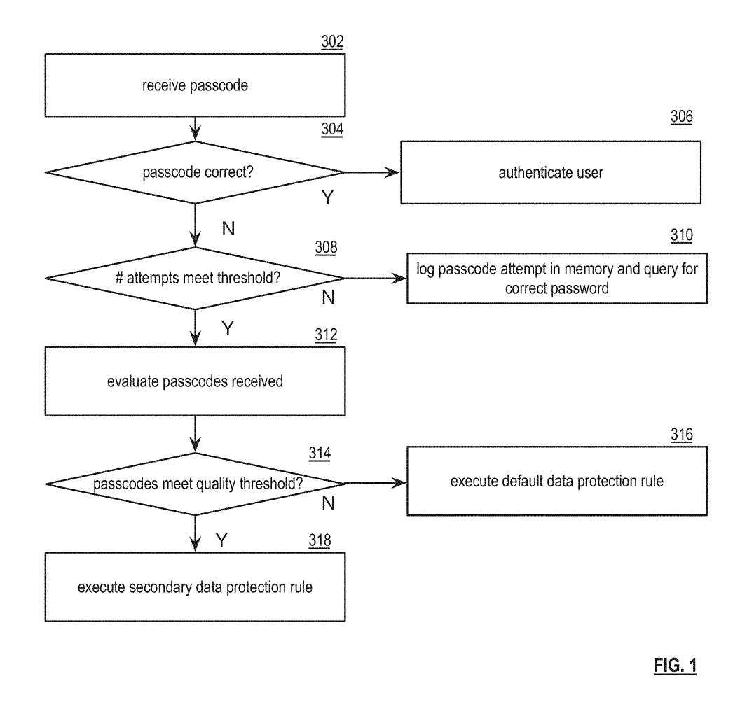

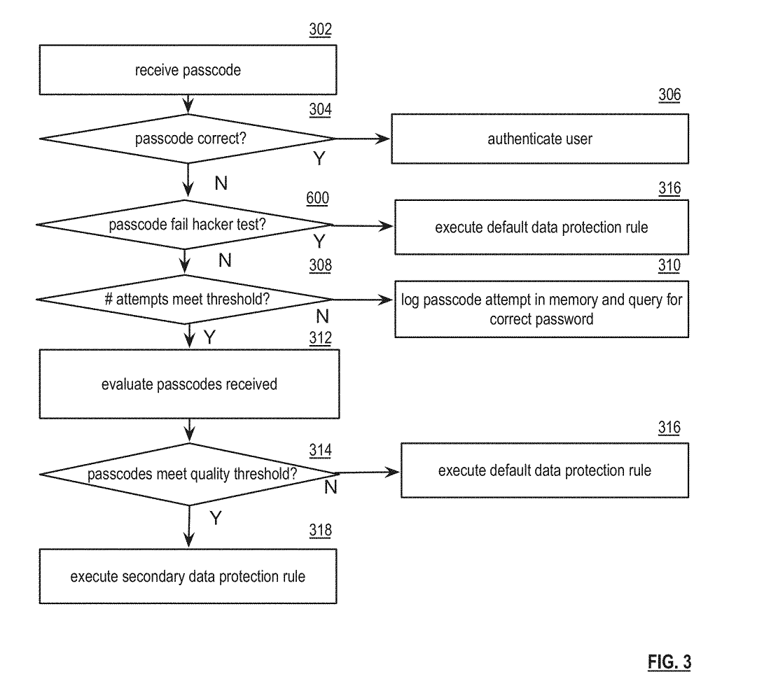

FIG. 1 is a logic diagram of an example of a method of performing modified authentication during passcode based authentication. In particular, a method is presented for detecting bona fide passcode entries and modifying the application of one or more data protection rules to avoid undesired data protection mechanisms in a device. In step 302 a passcode (or its machine modified equivalent) is received at a processor of a device. In step 304 the passcode is compared to an expected passcode (where an expected passcode is the one or more passcodes authorized for unlocking the device) and, when the passcode is authorized, the device is unlocked (step 306) for use. If the passcode is not an authorized passcode, it is rejected and the unauthorized passcode is logged in memory. Then, in step 308, when the number of unauthorized passcodes received is less than a threshold number, a passcode entry field will prompt the user for another passcode entry (step 310). Steps 302, 304 and 308 are then repeated, until, the number of unauthorized passcodes entered exceed the threshold. When the number of unauthorized passcodes entered exceed the threshold, in step 312 the unauthorized passcodes are evaluated according to a quality threshold to determine whether the last passcode received could be from a legitimate attempt by an otherwise authorized user of the device. Steps 312 and 314 are discussed with more detail with reference to FIG. 3, below.

In step 314, when the passcode does not meet the quality threshold one or more data protection rules can be applied, as shown in step 316. Data protection rules can include setting a timer for a predetermined period of time, during which no passcodes can be entered (lockout), setting an additional timer if/when the number of unauthorized passcodes received exceeds a second, higher threshold number and/or erasing all or a portion of the data on the device. Continuing with step 314, when the passcode meets the quality threshold the data protection policy provides for an alternate authentication path in step 318 to allow further attempts, or to initiate additional authentication data protection rule options to the data protection policy. In each case, the authentication may incorporate additional constraints, according to best practices in the security industries. In one embodiment the secondary data protection rule allows for an unauthorized attempt threshold to be increased, or reset to zero. In another example embodiment, the device can initiate communication with a device module or service provider to initiate a passcode reset. In yet another example embodiment, the device can initiate notification to one or more authorized users using a recovery text, voice call, or email. In these examples, the data protection policy can include rules requiring the device to be in lockout until an authorized user is able to respond to the notification.

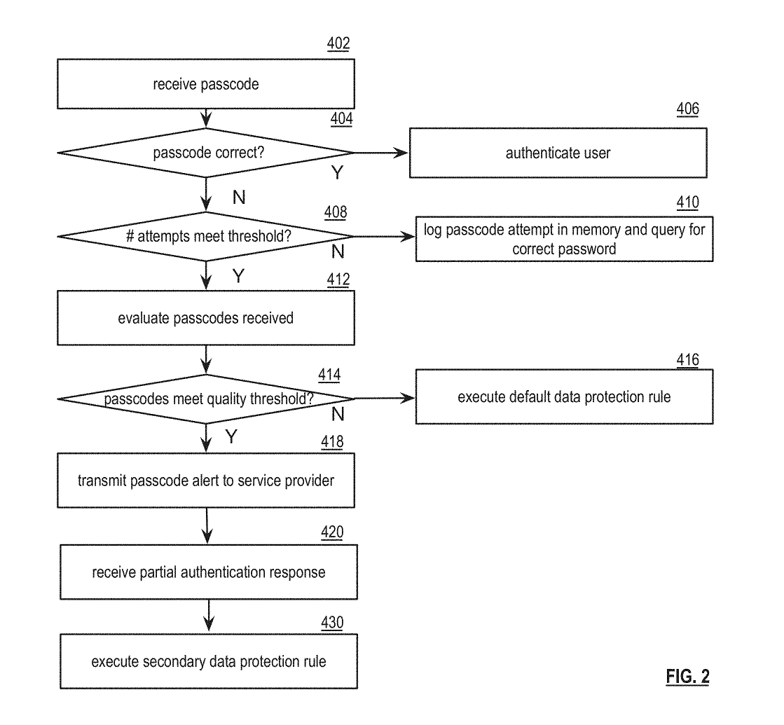

FIG. 2 is another logic diagram of an embodiment of a method of performing modified authentication during passcode based authentication. In particular, a method is presented for detecting bona fide passcode entries and modifying the application of one or more data protection rules to avoid unwarranted data protection mechanisms in a device. In step 402 a passcode (or its machine modified equivalent) is received at a processor of a device. In step 404 the passcode is compared to an expected passcode (where an expected passcode is the one or more passcodes authorized for unlocking the device) and, when the passcode is authorized, the device is unlocked (step 406) for use. If the passcode is not an authorized passcode it is rejected and the unauthorized passcode is logged in memory and in step 408 when the number of unauthorized passcodes received is less than a threshold number a passcode entry field will prompt for another passcode entry (step 410). Steps 402, 404 and 408 are then repeated, until, the number of unauthorized passcode attempts exceeds the threshold. When the number of unauthorized passcodes entered exceed the threshold, in step 412 the unauthorized passcodes are evaluated according to a quality threshold to determine whether the last passcode received could be from a legitimate attempt by an otherwise authorized user of the device. Steps 412 and 414 are discussed with more detail with reference to FIG. 3, below.

In step 414, when the passcode does not meet the quality threshold one or more data protection rules can be applied in step 416, as discussed above. Continuing with step 414, when the passcode meets the quality threshold the method continues at step 418, where a passcode alert is transmitted to a service provider or to a security entity. The passcode alert can take many forms, including, but not limited to, a simple indicator, an encrypted compilation of recent passcode entries, a request for further analysis of recent passcode entries and/or a list of quality indicators. The service provider can engage additional rules, such as evaluating whether the device has been reported stolen or is subject to heightened security restrictions. In step 420 the device receives an authorization from the service provider to use alternate data protection rules and in step 430 the alternate data protection rules are used as authorized. In each case, the authentication may incorporate additional constraints, according to best practices in the security industries. As detailed with regard to FIG. 1, the alternate data protection rules can allow for further passcode entry attempts, or to initiate additional authentication options.

FIG. 3 is another logic diagram of an embodiment of a method of performing modified authentication during passcode based authentication. In particular, each unauthorized passcode logged into memory is analyzed to determine whether it is a bona fide passcode entry attempt. As in FIG. 1, in step 302 a passcode (or its machine modified equivalent) is received at a processor of a device. In step 304 the passcode is compared to an expected passcode and, when the passcode is authorized, the device is unlocked (step 306) for use. If the passcode is not an authorized passcode it is compared in step 600 (“hacker test”) to a list of pre-determined suspect passcodes that can indicate an attempt by a person trying to gain unauthorized access to the device (such as a “hacker”). For example, common hacker attempts, such as using consecutive numbers, or simple passcodes, such as a user's first or last name could be provided in a list of common illicite passcode candidates. The list could contain any number of identifying characteristics as identified by those using best practices in the security industries. Once a hacker attempt has been identified the default data protection can be implemented immediately, so as to protect the device from additional attempts. Once the passcode entry survives the “hacker test” it can follow the steps 308-318 of FIG. 1 or steps 408-418 of FIG. 2 to meet the objectives of the present invention. Alternatively, each successive passcode entry that fails to meet the quality threshold can be analyzed against previously received passcode(s) to determine whether the received passcode entries follow a known or suspected pattern indicative of an attempt by a hacker. Examples include consecutive numbers and/or other patterns that are indicative of machine hacking. Consecutive passcode entries can also be subjected to a learning or artificial intelligence engine to determine whether the entries are likely be from an attempt to gain unauthorized entry to the device.

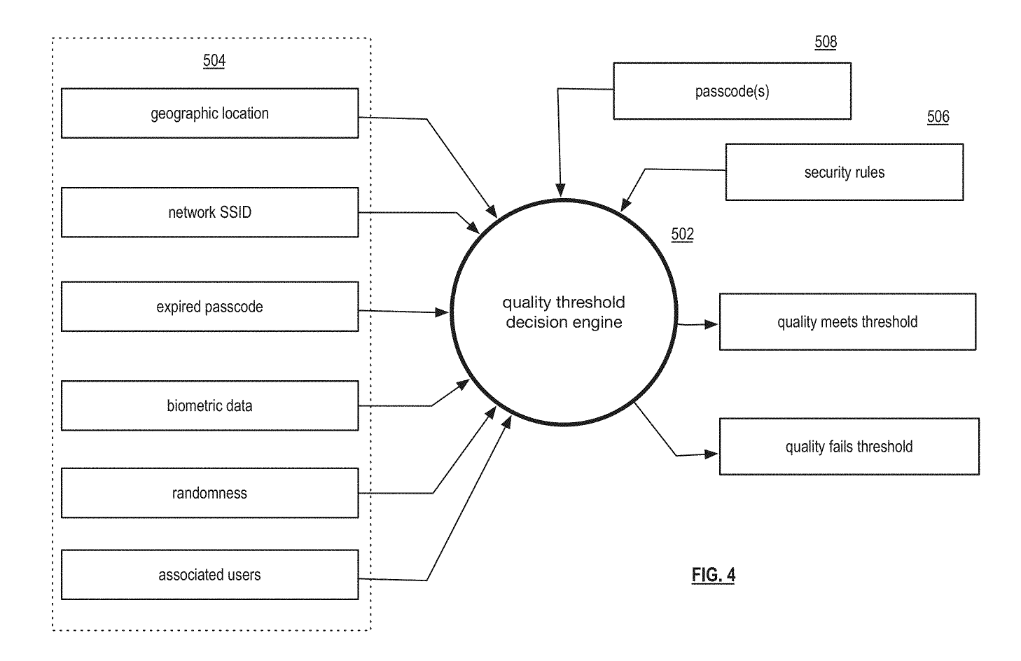

FIG. 4 provides an example of a schematic of a passcode quality threshold decision engine (decision engine) 502 for use in determining whether a passcode meets a quality threshold. It should be understood that FIG. 4 is provided for illustrative purposes only, and that each element can be represented by a number of hardware and/or software options. Quality metrics 504, along with security rules 506 and the received passcodes (or passcode) 508 are provided to quality threshold decision engine 502. Decision engine 502 applies one or more of the quality metrics 504 according to security rules 506 to determine whether received passcode(s) meet a quality threshold. Security rules 506 may include specific rules applicable in the various embodiments discussed above, including comparison to suspect hacker passcodes.

For example, the location of a device is provided to decision engine 502 at the time an incorrectly entered passcode is entered, and when the location is within accepted geographic limits, as determined according to security rules 506, the passcode is determined to have met the quality threshold. In another example, the network name or SSID is provided to the decision engine 502 and when the network name is included in a list of accepted networks, the passcode is determined to have met the quality threshold. In some cases, a quality metric can include the provided metric, along with a library or list of approved or expected values for the given metric, such that the provided metric is compared to the associated library or list. The list can be manually created, automatically assigned, or automatically learned as the device is used.

In various embodiments the decision engine, along with other security operations can be executed on a tamper-resistant platform, such as a Secure Element (SE), capable of securely hosting applications and their confidential and cryptographic data (e.g. key management) in accordance with the rules and security requirements set forth by a set of well-identified trusted authorities. Form factors for SEs include Universal Integrated Circuit Cards (UICC), embedded SEs and microSDs. In the case of UICC and microSD the SE is removable.

In one embodiment, an unauthorized passcode is received, initiating one or more biometric sensors to collect additional information about the user responsible for the passcode attempts. For example, the image sensor can be used to capture an image of whatever the image sensor is currently receiving. The captured image can then be compared to a library of images associated with one or more authorized users and the result input to the decision engine. Other examples include collecting data from sensors associated with the biometric metrics detailed in FIG. 7, along with any other conceivable biometric measurements.

Quality metrics 504 can include the relationship between an incorrectly entered passcode and one or more passcodes that have expired for some reason. For example, if a received passcode compares favorably to an expired passcode, the decision engine 502 can use this, alone or in combination with other quality metrics, to determine that the quality threshold has been met. In a further example, the received (but unauthorized) passcode can be compared to other logged (but also incorrect) passcodes received within a time window in order to calculate a measure of randomness that can indicate inadvertent passcode entries, or passcode entries being entered by a child playing with the device. In yet another example the received (but unauthorized) passcode is compared to the passcodes of “associated” users, such as family members and/or other trusted parties, and when the passcode is an associated user the decision engine 502 can determine that the quality threshold has been met.

As detailed in FIGS. 1 and 2, the determination that a received passcode meets the quality threshold does not by itself provide adequate authentication for the device, accordingly device security can be maintained while providing flexibility in the application of security policies. Additionally, any of the quality metrics 504 can be used in any combination by the decision engine 502 to determine whether a received passcode meets the quality threshold. Accordingly, based on security rules 506 and quality metrics 504, the flexibility provided to a user can be adjusted as required to meet security requirements. In some embodiments, the passcode entries are stored in a binary tree. In other embodiments, they are stored in a heap.

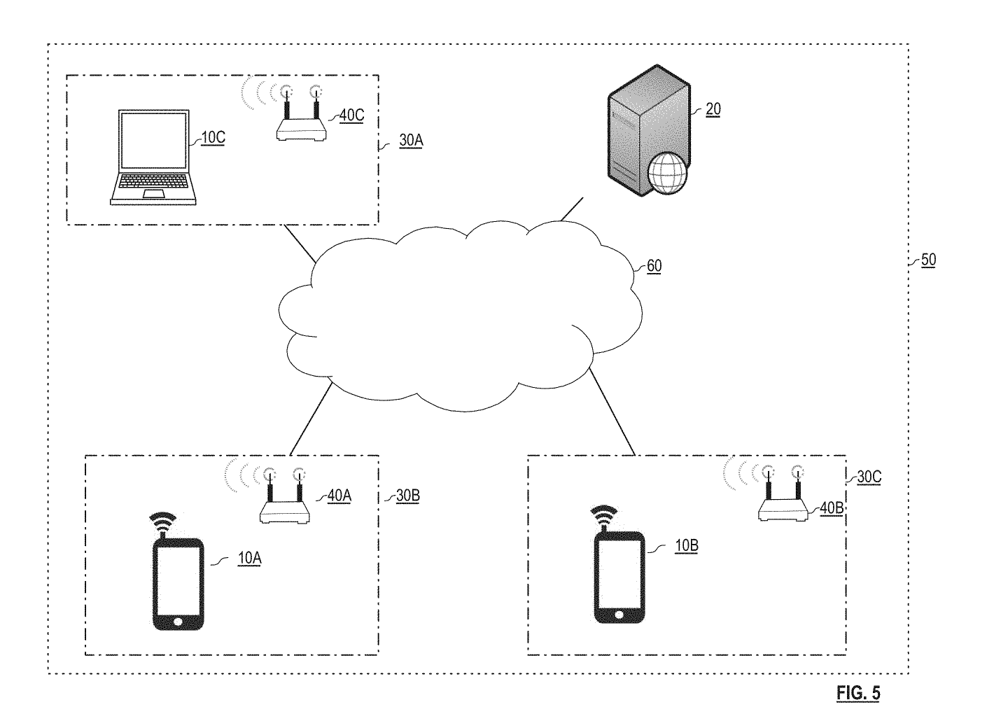

FIG. 5 presents an illustrative digital telecommunications environment 50 in which the various embodiments operate. As shown, digital telecommunications environment 50 includes one or more service providers 20 with which local computing devices, such as, for example, personal digital assistant (PDA) or cellular telephone 10A and 10B, and/or laptop computer 10C can communicate. Local computing devices 10A, 10B and 10C are found in local networks 30A, 30B and 30C, respectively. In the case of mobile devices 10A and 10B, communication can be made directly to the one or more service providers 20 and with local networks 30A and 30B, respectively simultaneously. Mobile devices 10A and 10B can be connected locally to wired/wireless routers 40A and 40B, respectively, while also being capable of communicating directly with service provider 20. Laptop computer 10C will be connected locally to local network 30A using wired/wireless router 40C and can be capable of communicating with service provider 20 over cloud network 60. Mobile devices 10A and 10B can also be capable of communicating with service provider 20 over cloud network 60.

It is understood that the types of computing devices 10A-N shown in FIG. 5 are intended to be illustrative only and that local networks 30A, 30B and 30C (with wired/wireless routers 40A, 40B and 40C, respectively) and cloud network 60 can be used to facilitate communication with any type of computerized device over any type of network and/or network addressable connection.

It is also understood that although this disclosure includes a detailed description on digital telecommunications environment, implementation of the teachings recited herein are not limited to the digital telecommunications environment illustrated in FIG. 4. Rather, embodiments of the present invention are capable of being implemented in conjunction with any other type of communication environment now known or later developed.

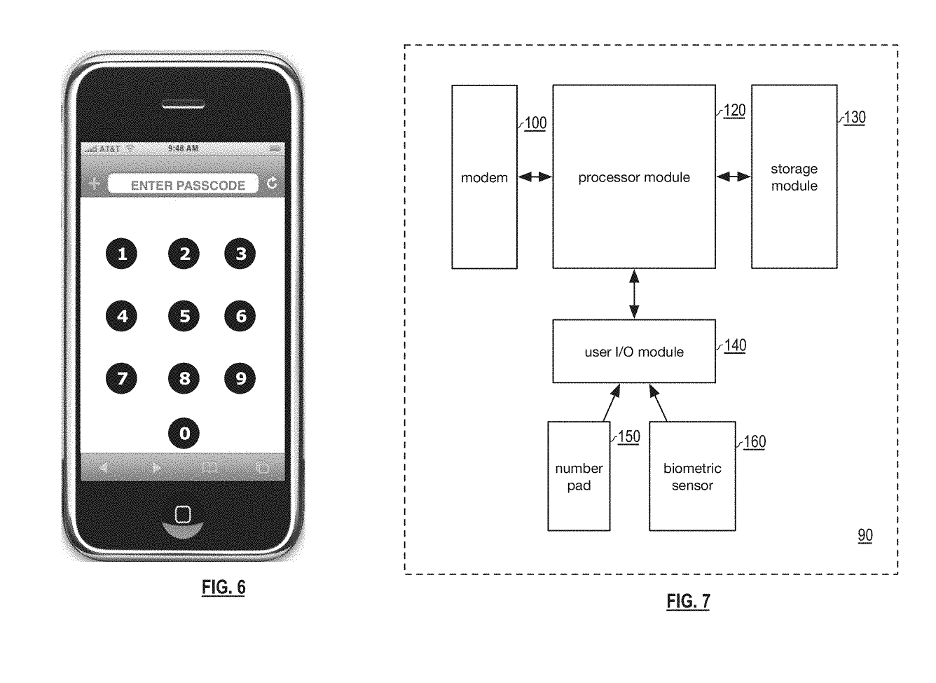

Referring now to FIG. 6, an example of a passcode entry field (or passcode entry screen) for a mobile device is shown. It should be understood in advance that the layout, selection options, and functions shown in FIG. 6 are intended to be illustrative only and embodiments of the invention are not limited thereto. As depicted, the passcode entry is limited to selections 0-9, accordingly if the passcode length is 4 digits, there are 9999 number combinations available to a user for authentication. In the example illustration numbers are selectable using a number keypad. Additional options for passcode entry include tracking a finger motion pattern across the number selections, tracking gestures above the number selections, and additional options, with the only constraint being that the user enters a passcode consisting of numbers or other characters.

Passcode entry is used to prevent unauthorized use of the mobile or other device, thus a user must successfully negotiate the passcode entry field before the phone can be used for all or most purposes. Since the number combination are necessarily limited and transportable devices are easily lost or misplaced, device manufacturers have widely adopted protection schemes for passcode entry, such that a given device will be rendered either temporarily or permanently useless if an incorrect password is entered. Normally data protection schemes limit the number of password attempts a user will be allowed to try before one or more of the data protection schemes are executed. Various protection schemes are possible, including, but not limited to, locking the phone when a predetermined number of incorrect passcodes have been attempted and either setting a timer for a predetermined amount of time before another passcode entry can be attempted, or locking the phone until an administrative action is taken on the phone. Protection schemes can even include erasure of all or a portion of the data on the phone.

Passcode entry can be not always be necessary when biometric sensors are available to capture biometric data for a user. Biometric sensors, including but not limited to fingerprint sensors, facial recognition, EKG measurements, etc. are widely used and are effective authentication methodologies, however, even when they are available passcode entry is almost universally used as a backup authentication method and/or in multi-factor authentication schemes. Accordingly, device manufactures have included passcode entry fields on a variety of transportable devices.

FIG. 7 provides a simplified schematic of the relevant functional elements of an example mobile device 90. It should be understood in advance that the layout and functions shown in FIG. 7 are intended to be illustrative only and embodiments of the invention are not limited thereto, accordingly each of the identified elements of FIG. 7 could be combined with additional elements, and each element can represent many sub-elements. Mobile device 90 includes number pad 150, which can interface with user I/O module 140 to access processor module 120. Processor module 120 can include a single processor for executing all or most of the mobile device operations, or it can include multiple processors distributed according to different mobile device functions. For example, processor module 120 can incorporate a separate processor module to execute security functions for the mobile device, including authentication. Security functions can also be distributed across more than one module. Processor module 120 can also be responsible for controlling and processing various mobile device functions, such as image sensing, audio, video, and in some cases, processing biometric sensor output and separate baseband processors. Secure processing sub-elements of processor module 120 can include analysis of incorrectly entered passcode entries, along with managing security rules, such as data protection rules and other authentication functions. One or more processing sub-elements of processor module 120 can provide additional functions related to embodiments of the present invention, including, but not limited to biometric sensor processing.

Modem 100 can include the baseband components for cellular, wireless local area network (WiLAN) and Bluetooth communication, and other RF based communications. It is understood that baseband processing can be distributed across a number of elements, however, Modem 100 is intended to represent all such functions, even if they are distributed across many elements. Storage module 130 includes one or more memory elements for use by the mobile device and, as with other elements, can be distributed as sub-elements by application. For example, storage module 130 can incorporate a secure element for use by one or more elements providing security functions.

Biometric sensor 160 is shown connecting directly with user I/O module 140. In some examples, biometric sensor 160 can connect directly to processor module 120, or it can connect directly with modules (such as a secure element) responsible for executing security functions, bypassing user I/O module 140 and/or connecting via another I/O element. It should be understood that biometric sensor 160 can incorporate a host of biometric variations, including, but not limited to pressure sensors, optical readers, RF sensors, chemical sensors, DNA sensors, electrical conductivity sensors, capacitive sensors, resistive sensors, ultrasonic sensors and any other conceivable sensor for generating measurements of useful physiological or behavioral characteristics of a user.

As can be used herein, the terms “substantially” and “approximately” provide an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As can also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but can adjust its current level, voltage level, and/or power level. As can further be used herein, inferred coupling (i.e., where one element is coupled to another element by inference) includes direct and indirect coupling between two items in the same manner as “coupled to”. As can even further be used herein, the term “configured to”, “operable to”, “coupled to”, or “operably coupled to” indicates that an item includes one or more of power connections, input(s), output(s), etc., to perform, when activated, one or more its corresponding functions and can further include inferred coupling to one or more other items. As can still further be used herein, the term “associated with”, includes direct and/or indirect coupling of separate items and/or one item being embedded within another item.

As can be used herein, the term “compares favorably”, indicates that a comparison between two or more items, signals, etc., provides a desired relationship. For example, when the desired relationship is that signal 1 has a greater magnitude than signal 2, a favorable comparison can be achieved when the magnitude of signal 1 is greater than that of signal 2 or when the magnitude of signal 2 is less than that of signal 1. As can be used herein, the term “compares unfavorably”, indicates that a comparison between two or more items, signals, etc., fails to provide the desired relationship.

As can also be used herein, the terms “processing module”, “processing circuit”, “processor”, and/or “processing unit” can be a single processing device or a plurality of processing devices. Such a processing device can be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit can be, or further include, memory and/or an integrated memory element, which can be a single memory device, a plurality of memory devices, and/or embedded circuitry of another processing module, module, processing circuit, and/or processing unit. Such a memory device can be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices can be centrally located (e.g., directly coupled together via a wired and/or wireless bus structure) or can be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions can be embedded within, or external to, the circuitry comprising the state machine, analog circuitry, digital circuitry, and/or logic circuitry. Still further note that, the memory element can store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks can also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram can include a “start” and/or “continue” indication. The “start” and “continue” indications reflect that the steps presented can optionally be incorporated in or otherwise used in conjunction with other routines. In this context, “start” indicates the beginning of the first step presented and can be preceded by other activities not specifically shown. Further, the “continue” indication reflects that the steps presented can be performed multiple times and/or can be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process can include one or more of the aspects, features, concepts, examples, etc. described with reference to one or more of the embodiments discussed herein. Further, from figure to figure, the embodiments can incorporate the same or similarly named functions, steps, modules, etc. that can use the same or different reference numbers and, as such, the functions, steps, modules, etc. can be the same or similar functions, steps, modules, etc. or different ones.

Unless specifically stated to the contra, signals to, from, and/or between elements in a figure of any of the figures presented herein can be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that can include or operate in association with a memory that stores operational instructions. A module can operate independently and/or in conjunction with software and/or firmware. As also used herein, a module can contain one or more sub-modules, each of which can be one or more modules.

The present invention can be a system, a method, and/or a computer program product at any possible technical detail level of integration. The computer program product can include a computer readable storage medium (or media) having computer readable program instructions thereon for causing a processor to carry out aspects of the present invention.

As can further be used herein, a computer readable memory includes one or more memory elements. A memory element can be a separate memory device, multiple memory devices, or a set of memory locations within a memory device. Such a memory device can be a read-only memory, random access memory, volatile memory, non-volatile memory, static memory, dynamic memory, flash memory, cache memory, and/or any device that stores digital information. The memory device can be in a form a solid-state memory, a hard drive memory, cloud memory, thumb drive, server memory, computing device memory, and/or other physical medium for storing digital information.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for providing authentication of a device, the method comprising:
receiving, by the device, a passcode entry;
in response to determining that the received passcode entry does not match an authorized passcode entry stored in a device memory:
executing a notification to indicate that the received passcode is an incorrect passcode; and
requesting entry of another passcode;
in response to determining that a consecutive threshold number of received passcodes do not match an authorized passcode entry stored in the device memory, determining whether a threshold number of received passcode entries meets a predetermined quality threshold;
in response to determining that the threshold number of received passcode entries meets the predetermined quality threshold, transmitting, by the device, an alert to an authentication service;
receiving, by the device, a partial authentication response from the authentication service; and
based on the partial authentication response, exchanging a first data protection rule for the device for a second data protection rule for the device.

2. The method of claim 1, wherein the predetermined quality threshold is determined, at least partially, based on a location of the device when receiving the passcode entry, wherein one or more locations are stored in the device memory and further wherein the determining whether the threshold number of received passcode entries meets the predetermined quality threshold is based on the location being equal to the one or more locations stored in the device memory.

3. The method of claim 1, wherein the predetermined quality threshold is determined, at least partially, based on a network connected to the device when receiving the passcode entry, and wherein one or more network addresses associated with the network are stored in the device memory, and further wherein the determining, by the device, whether the threshold number of received passcode entries meet the predetermined quality threshold is based on a network address associated with the network connected to the device when receiving the passcode entry being equal to the one or more network addresses stored in the device memory.

4. The method of claim 3, wherein the network address includes a service set identifier (SSID) and each of the one or more network addresses stored in the device memory are associated with a different SSID.

5. The method of claim 1, wherein the predetermined quality threshold is determined, at least partially, based on a comparison of one or more passcode entries of the threshold number of received passcode entries to one or more expired passcode entries stored in the first device memory, and further wherein the determining whether the threshold number of received passcode entries meet the predetermined quality threshold is based on the one or more passcode entries being the same as at least one of the one or more expired passcode entries stored in the first device memory.

6. The method of claim 1, further comprising:
when the threshold number of received passcode entries meet the predetermined quality threshold, activating an image sensor associated to the device to generate an image;
comparing the image to a stored library of images; and
when the image compares favorably to one or more images in the stored library of images, transmitting an alert to an authentication service;
receiving, from the authentication service, a partial authentication response; and
based on the partial authentication response, using a third data protection rule for the device.

7. The method of claim 1, wherein the first data protection rule includes at least one of locking use of the device for a time period and deleting at least some data stored on the device, and further wherein the second data protection rule includes at least one of resetting a passcode entry count to zero, activating a passcode entry reset protocol and activating an alternative passcode entry mode.

8. A system for authenticating a device that includes a processor, the system comprising:
a first module, when operable within a computing device, causes the computing device to:
receive a passcode entry from a user;
a second module, when operable within the computing device, causes the computing device to:
determine whether the passcode entry matches an authorized passcode stored in a device memory;
when the passcode entry does not match an authorized passcode entry stored in the device memory, execute a notification to indicate that the received passcode is an incorrect passcode; and
request entry of another passcode;
a second module, when operable within the computing device, causes the computing device to:
determine whether a consecutive threshold number of received passcode entries do not match an authorized passcode entry stored in the device memory; and
when a consecutive threshold number of received passcode entries do not match an authorized passcode entry stored in the first device memory, determine whether the threshold number of received passcodes meets a predetermined quality threshold;
a third module, when operable within the computing device, causes the computing device to:
when the threshold number of received passcodes meets the predetermined quality threshold, transmit an alert to an authentication service
a fourth module, when operable within the computing device, causes the computing device to:
receive a partial authentication response from the authentication service; and
based on the partial authentication response, exchange a first data protection rule for the device for a second data protection rule for the device.

9. The system of claim 8, wherein the predetermined quality threshold is determined, at least partially, based on a network connected to the device when receiving the passcode entry, and wherein one or more network addresses associated with the network are stored in the device memory, and further wherein the second module, when operable within the computing device, further causes the computing device to:
determine whether the threshold number of received passcodes meet the predetermined quality threshold based on a network address associated with the network connected to the device when receiving the passcode entry being equal to the one or more network addresses stored in the device memory.

10. The system of claim 8, wherein the predetermined quality threshold is determined, at least partially, based on a comparison of one or more of the threshold number of received passcodes to one or more expired passcode entries stored in the first device memory, and further wherein the second module, when operable within the computing device, further causes the computing device to:
determine whether the passcode entry meets the predetermined quality threshold based on one or more of the threshold number of received passcodes being the same as at least one of the one or more expired passcode entries stored in the device memory.

11. The system of claim 8, wherein the first data protection rule is at least one of locking use of the device for a time period and deleting at least some data stored on the device and further wherein the second data protection rule is at least one of resetting a passcode entry count to zero, activating a passcode entry reset protocol and activating an alternative passcode entry mode.

12. The system of claim 8, further comprising:
a fifth module, when operable within the computing device, causes the computing device to:
when the threshold number of received passcodes meet the predetermined quality threshold, activate an image sensor associated to the device to generate an image;
an eleventh module, when operable within the computing device, causes the computing device to:
compare the image to a stored library of images; and
when the image compares favorably to one or more images in the stored library of images, transmit the alert to the authentication service.

13. The system of claim 8, wherein the first data protection rule includes at least one of locking use of the device for a time period and deleting at least some data stored on the device, and further wherein the second data protection rule includes at least one of resetting a passcode entry count to zero, activating a passcode entry reset protocol and activating an alternative passcode entry mode.

14. A method for providing authentication of a device, the method comprising:
receiving, by the device, a passcode entry;
in response to determining that the received passcode entry does not match an authorized passcode entry stored in a device memory:
executing a notification to indicate that the received passcode is an incorrect passcode; and
requesting entry of another passcode;
in response to determining that a consecutive threshold number of received passcodes do not match an authorized passcode entry stored in the device memory, determining whether the threshold number of received passcodes meets a predetermined quality threshold;
in response to determining that the threshold number of received passcodes meets the predetermined quality threshold, exchanging a first data protection rule for the device for a second data protection rule for the device.

15. The method of claim 14, wherein the predetermined quality threshold is determined, at least partially, based on a location of the device when receiving the passcode entry, and further wherein one or more locations are stored in the device and the determining whether the threshold number of received passcodes meets the predetermined quality threshold is based on the location being equal to the one or more locations stored in the device.

16. The method of claim 14, wherein the predetermined quality threshold is determined, at least partially, based on a location of the device when receiving the passcode entry, wherein one or more locations are stored in a device memory and further wherein the determining whether the threshold number of received passcodes meet the predetermined quality threshold is based on the location being equal to the one or more locations stored in the device memory.

17. The method of claim 14, wherein the predetermined quality threshold is determined, at least partially, based on a network connected to the device when receiving the passcode entry, and wherein one or more network addresses associated with the network are stored in a device memory, and further wherein the determining, by the device, whether the threshold number of received passcodes meet the predetermined quality threshold is based on a network address associated with the network connected to the device when receiving the passcode entry being equal to the one or more network addresses stored in the device memory.

18. The method of claim 14, wherein the predetermined quality threshold is determined, at least partially, based on a comparison of one or more passcode entries of the threshold number of received passcodes to one or more expired passcode entries stored in the first device memory, and further wherein the determining whether the threshold number of received passcodes meet the predetermined quality threshold is based on the one or more passcode entries of the of the threshold number of received passcodes being the same as at least one of the one or more expired passcode entries stored in the first device memory.

19. The method of claim 14, further comprising:
when the of the threshold number of received passcodes meet the predetermined quality threshold, activating an image sensor associated to the device to generate an image;
comparing the image to a stored library of images; and
when the image compares favorably to one or more images in the stored library of images, transmitting an alert to an authentication service;
receiving, from the authentication service, a partial authentication response; and
based on the partial authentication response, using a third data protection rule for the device.

20. The method of claim 14, wherein the first data protection rule includes at least one of locking use of the device for a time period and deleting at least some data stored on the device, and further wherein the second data protection rule includes at least one of resetting a passcode entry count to zero, activating a passcode entry reset protocol and activating an alternative passcode entry mode.
